(19) United States
(12) Patent Application Publication
(10) Pub. No.: US 2022/0182970 A1
(43) Pub. Date: Jun. 9, 2022

(54) PAGING ON SIDELINK

(71) Applicant: QUALCOMM Incorporated, San Diego, CA (US)

(72) Inventors: Kaidong WANG, San Diego, CA (US); Jelena DAMNJANOVIC, Del Mar, CA (US); Juan MONTOJO, San Diego, CA (US); Tao LUO, San Diego, CA (US)

(21) Appl. No.: 17/457,835

(22) Filed: Dec. 6, 2021

Related U.S. Application Data
(60) Provisional application No. 63/123,359, filed on Dec. 9, 2020.

(51) Int. Cl. H04W 68/00; H04W 4/90; H04W 72/04

(52) U.S. Cl. CPC H04W 68/005; H04W 4/90; H04W 92/18; H04W 72/0446; H04W 72/0453; H04W 72/0406

(57) ABSTRACT

The method of wireless communication may include a relay user equipment (UE) and a target UE. The relay UE may receive, from a base station, a paging relay request message including a paging message for the target UE, the paging relay request message requesting the relay UE to transmit the paging message to the target UE, and transmit a sidelink control information (SCI) type 1 (SCI-1) and/or an SCI type 2 (SCI-2) and the paging message to the target UE through one or more sidelink channels based on the received paging relay request message. The target UE may decode the paging message received from the relay UE.

### CROSS REFERENCE TO RELATED APPLICATION(S)

This application claims the benefit of and priority to U.S. Provisional Application Ser. No. 63/123,359, entitled “METHOD AND APPARATUS FOR PAGING ON SIDELINK” and filed on Dec. 9, 2020, which is expressly incorporated by reference herein in its entirety.

### TECHNICAL FIELD

The present disclosure generally relates to communication systems, and more particularly, to a method for paging utilizing sidelink communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method of wireless communication of a first user equipment (UE) may include receiving, from a base station, a paging relay request message including a paging message for a target UE, the paging relay request message requesting the relay UE to transmit the paging message to the target UE, and transmitting the paging message to the target UE through one or more sidelink channels based on the received paging relay request message. The target UE may receive, from the relay UE, a paging message through one or more sidelink channels, and decode the received paging message.

The one or more sidelink channels may include a physical sidelink control channel (PSCCH) and a physical sidelink shared channel (PSSCH). The paging message to the target UE may include sidelink control information (SCI) transmitted in the PSCCH to the target UE, the SCI indicating time-frequency resources allocated for the paging message within the PSSCH, and the paging message transmitted in the PSSCH to the target UE, the paging message being transmitted in the time-frequency resources indicated through the transmitted SCI. The SCI may be transmitted in an SCI format 1 (SCI-1) message.

The paging message may be transmitted with a header, where the header may include a source identifier (ID) identifying the relay UE, a destination ID identifying the target UE, and a frame type identifying that paging message may be for paging, and the paging message include a paging type, and at least one identity associated with paged UEs, the at least one identity including an identity of the target UE.

The paging message may include an additional message indicating physical random access channel (PRACH) resources for random access, the paging type being associated with triggering the RRC setup through a Uu interface. The paging message may include an additional message indicating sidelink resources for a unicast connection setup, the paging type being associated with triggering the RRC setup through a PC5 interface. The paging message may include an additional message indicating new system information (SI), the paging type being associated with a system information modification. Furthermore, the paging message may include an additional message indicating an earthquake and tsunami warning system (ETWS)/commercial mobile alert system (CMAS) message, the paging type being associated with an ETWS/CMAS notification.

The paging message transmitted by the UE to the target UE may include the first SCI in the PSCCH, and the second SCI in the PSSCH to the target UE the first SCI indicating time-frequency resources allocated for the second SCI and the paging message within the PSSCH. The second SCI may indicate information for decoding the paging message, the second SCI being transmitted in the time-frequency resources indicated through the transmitted first SCI, and transmitting the paging message in the PSSCH to the target UE, the paging message being transmitted in the time-frequency resources indicated through the transmitted first SCI. The first SCI may be transmitted in the SCI-1 message, and the second SCI may be transmitted in the SCI-2 message. The paging type may be transmitted in the SCI-2 in the PSSCH.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates examples of a sidelink slot structure.

FIG. 5 illustrates an example of wireless communication.

FIG. 6 illustrates an example diagram illustrating a slot structure of a sidelink communication.

FIG. 7 illustrates an example of a frame format of the paging message.

FIG. 8 illustrates an example diagram illustrating a slot structure of a sidelink communication.

FIG. 9 illustrates an example of a frame format of the paging message.

FIG. 10 is a call-flow diagram of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus.

FIG. 16 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

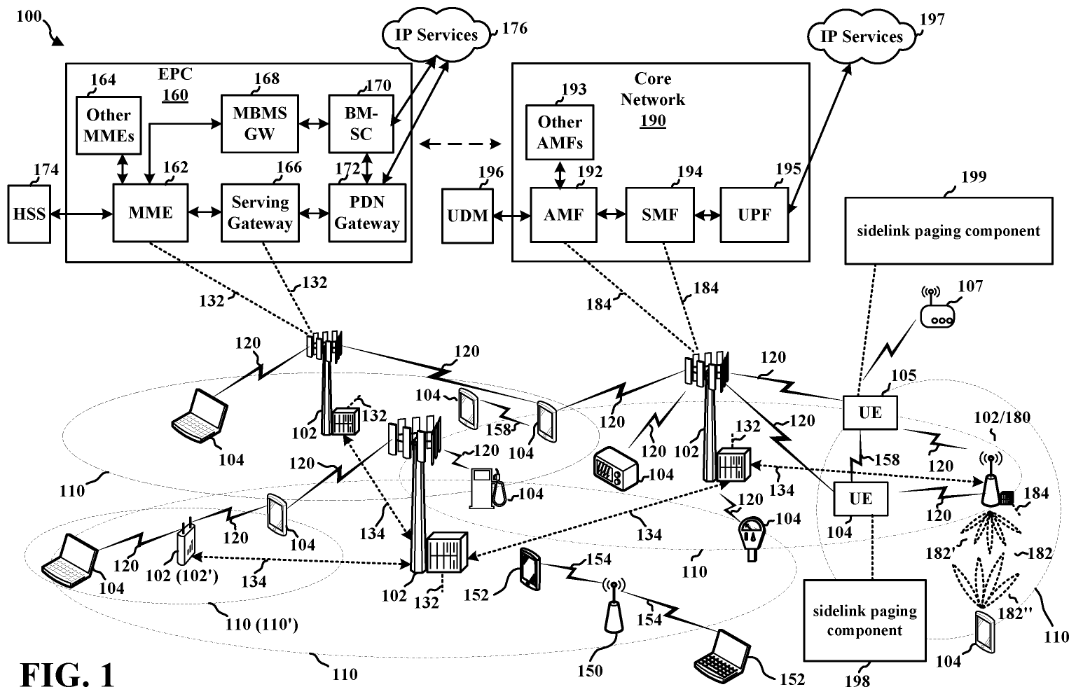

FIG. 1 is a diagram illustrating an example of a wireless communications system and an access network 100. The wireless communications system (also referred to as a wireless wide area network (WWAN)) includes base stations 102, UEs 104 and 105, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

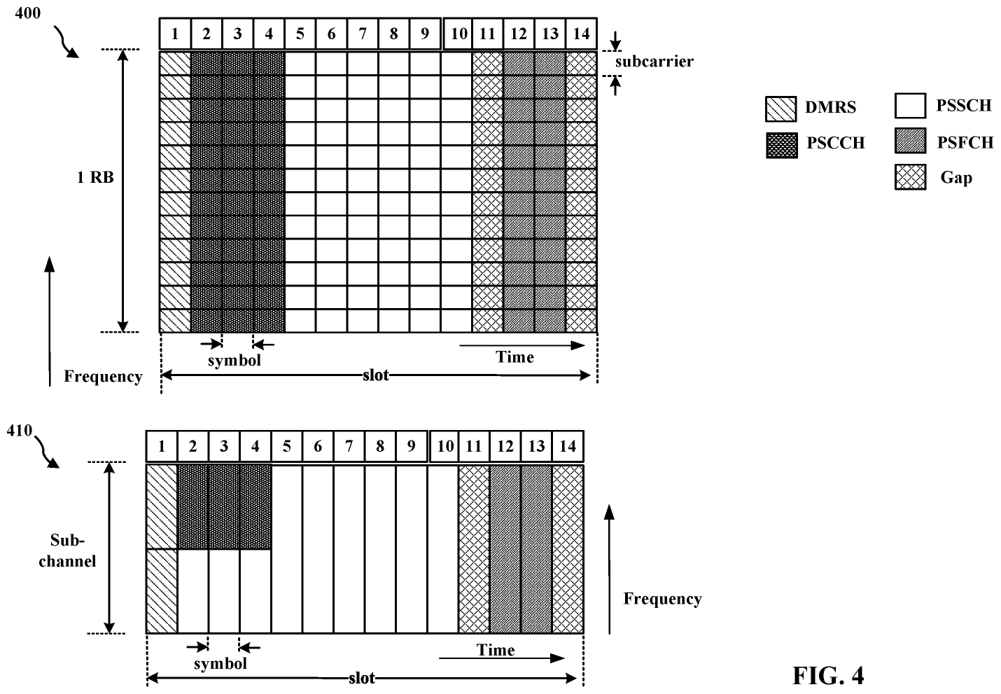

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR2-2, FR4, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE may be a relay UE 104 including a sidelink paging component 198 configured to transmit paging message to a target UE 105 on the sidelink communication. In certain aspects, the UE may be a target UE 105 including a sidelink paging component 199 configured to receive the paging message from the relay UE 104 on the sidelink communication.

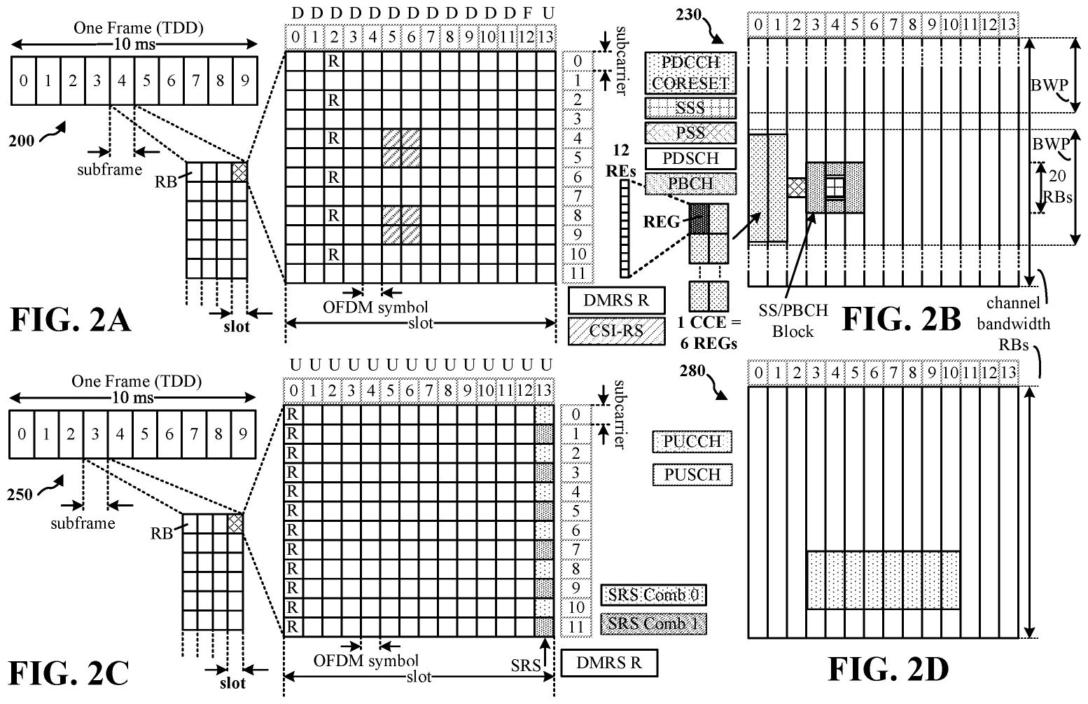

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

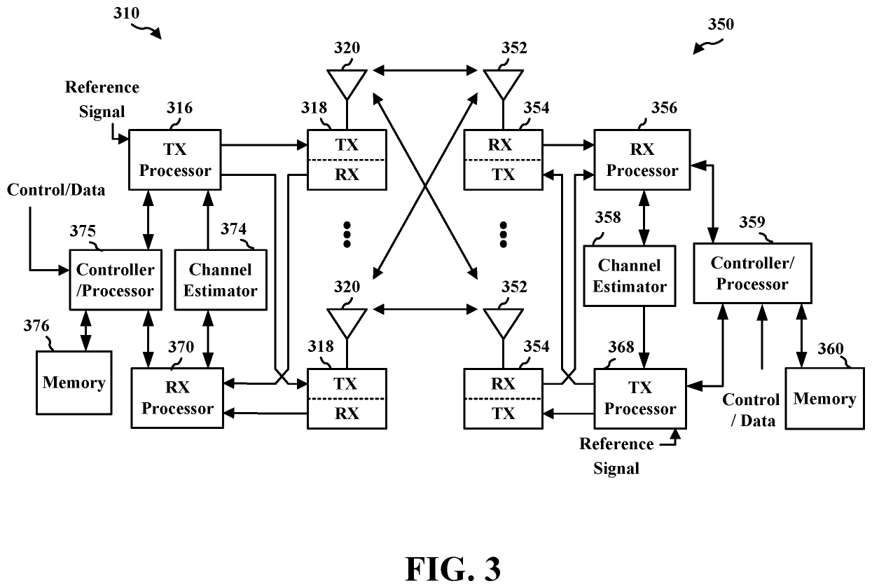

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to an RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with the sidelink paging component 198 of the relay UE 104 of FIG. 1. At least one of the TX processor 368, the RX processor 356, and the controller/processor 359 may be configured to perform aspects in connection with the sidelink paging component 199 of the target UE 105 of FIG. 1.

FIG. 4 illustrates example diagrams 400 and 410 of example slot structures that may be used for sidelink communication (e.g., between the relay UE 104, the target UE 105, RSU 107, etc.). The slot structure may be within a 5G/NR frame structure. Although the following description may be focused on 5G NR, the concepts described herein may be applicable to other similar areas, such as LTE, LTE-A, CDMA, GSM, and other wireless technologies. This is merely one example, and other wireless communication technologies may have different frame structures and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single slot transmission, e.g., which may correspond to a 0.5 ms transmission time interval (TTI). In some examples, slots may be aggregated, e.g., an aggregation of two 0.5 ms TTIs. Diagram 400 illustrates a single RB, whereas diagram 410 illustrates multiple RBs.

A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH, and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some examples.

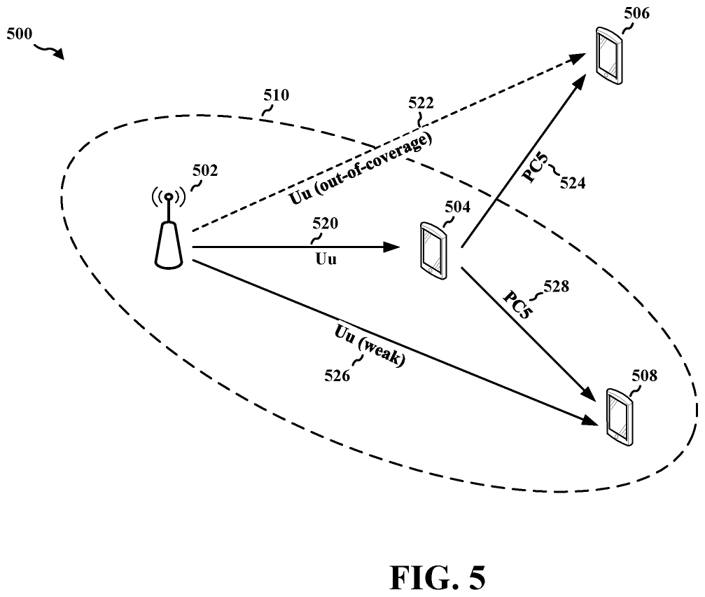

FIG. 5 illustrates an example 500 of wireless communication. The example 500 of the wireless communication may include a base station 502 and UEs including a relay UE 504, a first target UE 506, and a second target UE 508. In some aspects, when the UEs do not have any ongoing data transmissions with the base station 502 or with each other, the UEs may enter an IDLE state or an INACTIVE state. When the base station 502 receives new data to be transmitted to at least one of the UEs in the IDLE state or the INACTIVE state, the base station 502 may transmit a paging message to the UEs in the IDLE state, so the UEs in the IDLE state or the INACTIVE state may respond corresponding to a type of the paging message sent from the base station 502 to the UE in the IDLE state or the INACTIVE state. The paging message may be transmitted for various purposes. For example, the base station 502 may transmit the paging message to trigger an RRC setup, modify system information, and/or broadcast an emergency message such as an earthquake and tsunami warning system (ETWS)/commercial mobile alert system (CMAS) message.

In some aspects, the base station 502 may indicate the type of paging on the Uu interface in various ways. Table 1 indicates the identifier that the base station 502 may use to indicate the type of the paging when transmitting the paging message to the UEs on the Uu interface.

TABLE 1
paging type and identifier on Uu interface

| Paging type | Identifier |
|---|---|
| Triggering RRC Setup | RRC paging message on PDSCH |
| System Information | The first bit of DCI Format 1_0 short |
| Modification | message |
| ETWS/CMAS notification | The second bit of DCI Format 1_0 short |
| | message |

Accordingly, the base station 502 may transmit the RRC paging message on PDSCH to indicate that the type of the paging message is for triggering an RRC setup. The base station 502 may transmit DCI and indicate in the first bit of DCI format 1_0 short message that the type of the paging message is for a system information modification. The base station 502 may transmit the DCI and indicate in the second bit of DCI format 1_0 short message that the type of the DCI is the paging message for ETWS/CMAS notification. Some aspects include transmitting the paging message to a target UE through a relaying UE on a sidelink communication.

Accordingly, the base station 502 may transmit the paging message to the relay UE 504 that is in the IDLE state or INACTIVE state through the Uu interface. The base station may also transmit the paging message to the first target UE 506 and/or the second target UE 508 that are in the IDLE state or INACTIVE state through the Uu interface.

In some aspects, the base station 502 may not be able to successfully transmit the paging message to the first target UE 506 and/or the second target UE 508 due to the status of the Uu interface between the base station 502 and the first target UE 506 and/or the second target UE 508 that are in the IDLE state or INACTIVE state.

In some aspects, the first target UE 506 may be out-of-coverage, where the base station 502 cannot page the first target UE 506. That is, the base station 502 may determine to transmit the paging message to the first target UE 506 and attempt to transmit the paging message to the first target UE 506 through the Uu interface 522 between the base station 502 and the first target UE 506. However, the first target UE 506 may be outside the coverage 510 of the base station 502, and the base station 502 may not successfully transmit the paging message to the first target UE 506 that is outside the coverage 510 of the base station 502.

Accordingly, the base station 502 may ask the relay UE 504 to forward the paging message to reach the first target UE 506. The relay UE 504 may send the paging message to the target UE on the sidelink. That is, the base station 502 may transmit a paging relay request message to the relay UE 504 through the Uu interface 520 and request the relay UE 504 to transmit the paging message to the first target UE 506 through a PC5 interface 524 of sidelink communication.

In some aspects, the transmission of the paging message may fail due to a channel state of the Uu interface 526 between the base station 502 and the UE. That is, the base station 502 may determine to transmit the paging message to the second target UE 508 and attempt to transmit the paging message to the second target UE 508. However, the second target UE 508 may be located close to the boundary of the coverage 510 of the base station 502, or the signal may be physically blocked by interferences, and the connection between the base station 502 and the second target UE 508 through the Uu interface may have a weak or low signal level and/or high noise level. Therefore, the transmission of the paging message to the second target UE 508 may have high latency or may not be successfully transmitted to the second target UE 508.

Accordingly, the paging may utilize signal diversity by a repetition of the paging message to the second target UE 508 via a sidelink communication and thus reduce the latency. That is, the base station 502 may transmit the paging relay request message to the relay UE 504 through the Uu interface 520 and request the relay UE 504 to transmit the paging message to the second target UE 508 through the PC5 interface 528 of sidelink communication.

In some aspects, the designs of the paging message dedicated to the Uu interface, the direct link between the base station 502 and the UEs, may be used to transmit the paging message between the base station 502 and the UEs, and the design of the paging message on the sidelink (PC5 interface), i.e., the link between the relay UE 504 and the target UEs may be used to transmit the paging message between the relay UE 504 and the target UEs. In some aspects, the design of resource allocation and the signaling of the paging message on sidelink may be provided.

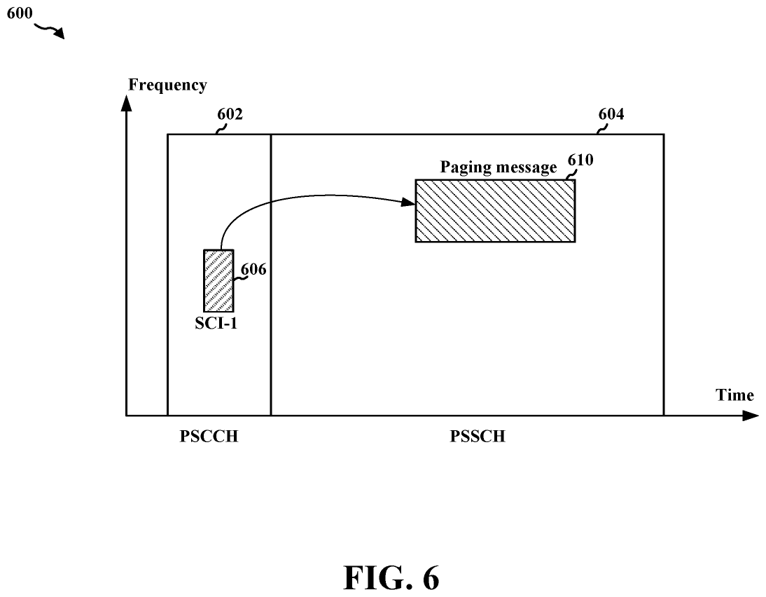

FIG. 6 illustrates an example diagram 600 illustrating a slot structure of a sidelink communication. The resource allocation on the sidelink may follow one of the two resource allocation modes. First, the base station may allocate the radio resources for the sidelink communications between UEs, including a relay UE and a target UE. Second, the UEs, including a relay UE and a target UE, may autonomously select the sidelink resources.

Based on the allocation of the radio resources for the sidelink communications, the sidelink channels for the sidelink communication on the PC5 interface may include a PSCCH 602 and a PSSCH 604. The relay UE may transmit sidelink control information (SCI) to the target UE in the PSCCH 602, and the relay UE may also transmit the paging message 610 to the target UE in the PSSCH 604.

The SCI may be provided in one stage and include a first stage control (SCI-1 606). The SCI-1 606 may be transmitted in the PSCCH 602 and include the information for the resource allocation of the paging message 610. That is, the relay UE may transmit the SCI-1 606 in the PSCCH 602 to indicate the resource allocation of the paging message 610 transmitted in the PSSCH 604. SCI-1 606 may be decodable by the UEs.

The paging information may be included in the paging message 610. That is, the relay UE may include the paging information from the paging relay request message received from the base station in the paging message 610 and transmit the paging message 610 to the target UE in the PSSCH 604. The paging message 610 on the sidelink may contain a list of paging items, and each item may include a target UE's UE-Identity/full paging record list in paging message 610 on the Uu interface, a paging type, and an additional message.

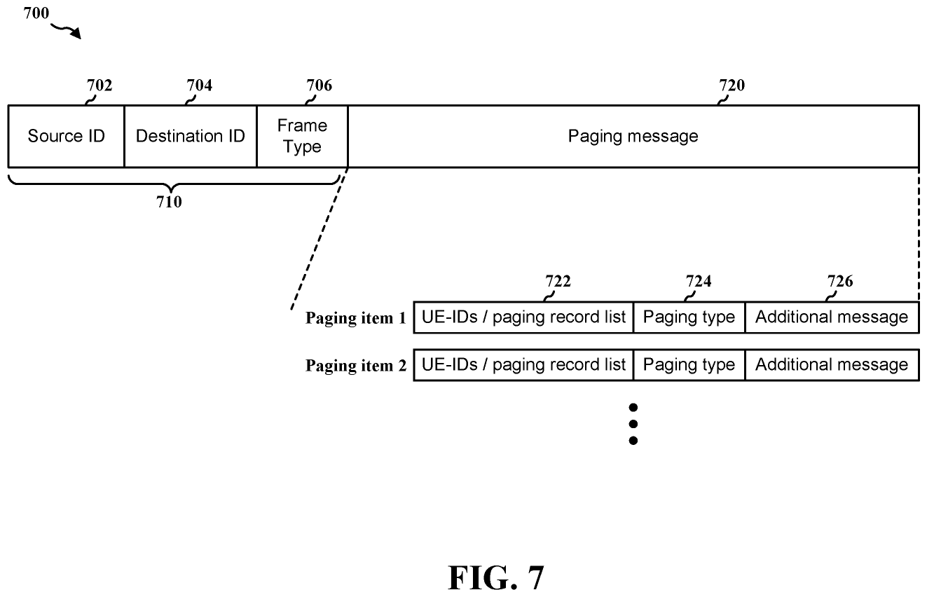

FIG. 7 illustrates an example of a frame format 700 of the paging message 720. The frame format 700 of the paging message 720 illustrates that the paging message 720 transmitted in the PSSCH may include a header 710. The header 710 may be a layer-2 frame header 710 of the paging message 720, and the header 710 may include a source ID 702, a destination ID 704, and a frame type 706.

The source layer-2 ID 702 may identify the relay UE. That is, the source ID 702 of the header 710 may identify the relay UE transmitting the paging message 720 to the target UE through the sidelink communication on the PC5 interface. The destination layer-2 ID 704 may identify the target UE. That is, the target ID of the header 710 may identify the target UE that the relay UE is transmitting the paging message 720 to through the sidelink communication on the PC5 interface. The frame type 706 may identify the type of the frame as paging. That is, the frame type 706 may indicate that the type of the frame is for transmitting the paging message 720.

In some aspects, the paging message 720 may include a list of paging items, and each of the paging items may include UE-identity/paging record list 722 identifying the UE paged by the base station, a paging type 724 indicating the type of the paging, and an additional message 726 indicating one of SI, ETWS/CMAS message, or PRACH resources.

The paging record list 722 may include the UE-identity of the target UE if the relay UE has the UE-identity of the target UE and knows that the paging message 720 is dedicated to the target UE based on the paging relay request message received from the base station. The paging record list 722 may include the full paging record list 722 in the paging message 720 on the Uu interface if the relay UE does not have the UE-identity of the target UE and does not know whether the paging message 720 is dedicated to the target UE.

The paging type 724 may be indicated in the paging message 720. The sidelink may have no DCI, and the paging type 724 may be indicated in the paging message 720 on the sidelink. That is, the relay UE may indicate the paging type 724 in the paging message 720 transmitted to the target UE on the sidelink communication. The paging type 724 may include triggering an RRC setup via the Uu interface or the PC5 interface, modifying the SI, or notifying the emergency message such as the ETWS/CMAS notification.

The relay UE may include the additional message 726 in the paging message 720 based on the paging type 724 of the paging message 720. The additional message 726 may be optional and be omitted. Table 2 illustrates the association between the paging type 724 and the content of the additional message 726 of the paging message 720.

TABLE 2
Paging type and additional message

| Paging type | Additional message |
|---|---|
| Triggering RRC Setup | PRACH resources for |
| through Uu | random access |
| Triggering RRC setup | Sidelink resource for unicast |
| through PC5 | connection setup |
| System Information Modification | New system information |
| ETWS/CMAS notification | ETWS/CMAS message |

The additional message 726 may include the PRACH resources for random access based on the paging type 724 being associated with triggering the RRC setup via the Uu interface. The additional message 726 may include the sidelink resources for a unicast connection setup based on the paging type 724 being associated with triggering the RRC setup through the PC5 interface. The additional message 726 may include new SI based on the paging type 724 being associated with the system information modification. The additional message 726 may include an emergency message such as the ETWS/CMAS message based on the paging type 724 being associated with the ETWS/CMAS notification.

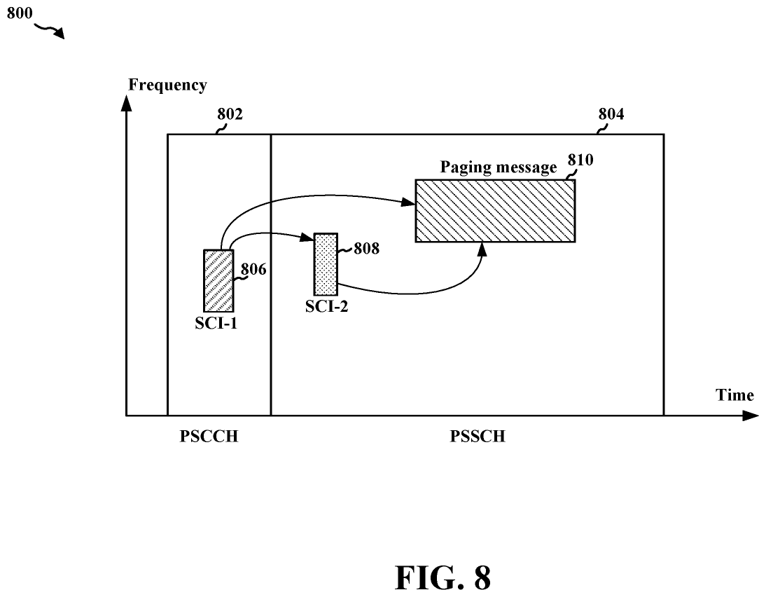

FIG. 8 illustrates an example diagram 800 illustrating a slot structure of a sidelink communication. The sidelink channels for the sidelink communication on the PC5 interface may include the PSCCH 802 and the PSSCH 804. In some aspects, the SCI may be provided in two stages and include the first stage control (SCI-1 806) and a second stage control (SCI-2 808). The SCI-1 806 may be transmitted in the PSCCH 802 and include the information for the resource allocation of the paging message 810 and the SCI-2 808, and for decoding the SCI-2 808. That is, the relay UE may transmit the SCI-1 806 in the PSCCH 802 to indicate the resource allocation of SCI-2 808 and paging message 810 in the PSSCH 804.

The SCI-1 806 may be decodable by the UEs, and the SCI-2 808 may have various formats. Accordingly, the SCI-2 808 may have different formats while maintaining the resource reservation in the SCI-1 806 for backward compatibility.

The SCI-2 808 may be transmitted in the PSSCH 804 and include information for decoding the paging message 810 transmitted in the PSCCH 802. In some aspects, the SCI-2 808 may include information for decoding the paging message 810. In case the SCI-2 808 includes the information for decoding the paging message 810, the paging message 810 transmitted in the PSSCH 804 may have the same frame structure as the frame format 700 of FIG. 7.

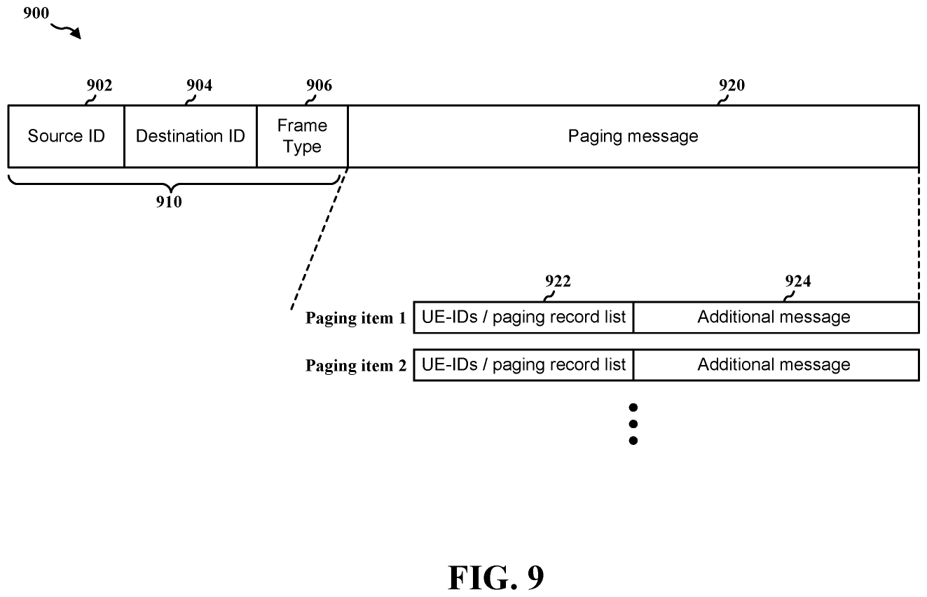

In some aspects, the SCI-2 808 may include the information for decoding the paging message 810 and a paging type of the paging message 810. That is, the SCI-2 808 may include the paging type of the paging message 810 as well as the information for decoding the paging message 810, and correspondingly, the paging message 810 may have a frame format (i.e., frame format 900 of FIG. 9) different from the frame format 700 of FIG. 7. Accordingly, the paging message 810 on the sidelink may contain a list of paging items, and each item may include the target UE's UE-Identity/full paging record list in the paging message 810 on the Uu interface and the additional message.

The paging type may be indicated in the SCI-2 808. That is, the relay UE may transmit the paging type in the SCI-2 808 transmitted to the target UE on the sidelink communication to indicate the paging type. The paging type may include triggering RRC setup through the Uu interface or the PC5 interface, modifying the SI, or notifying the emergency message such as the ETWS/CMAS notification.

FIG. 9 illustrates an example of a frame format 900 of the paging message 920. The frame format 900 of the paging message 920 illustrates that the paging message 920 transmitted in the PSSCH may include a header 910. The header 910 may be a layer-2 frame header of the paging message 920, and the header 910 may include a source ID 902, a destination ID 904, and a frame type 906.

The source layer-2 ID may identify the relay UE. That is, the source ID 902 of the header 910 may identify the relay UE transmitting the paging message 920 to the target UE through the sidelink communication on the PC5 interface. The destination layer-2 ID may identify the target UE. That is, the target ID of the header may identify the target UE that the relay UE is transmitting the paging message 920 to through the sidelink communication on the PC5 interface. The frame type 906 may identify the type of the frame as paging. That is, the frame type 906 may indicate that the type of the frame is for transmitting the paging message 920.

In some aspects, the paging message 920 may include a list of paging items, and each of the paging items may include the UE-identity/paging record list 922 identifying the UE paged by the base station and the additional message 924 indicating one of system SI, ETWS/CMAS message, PRACH resources.

The paging record list 922 may include the UE-identity of the target UE if the relay UE has the UE-identity of the target UE and knows that the paging message 920 is dedicated to the target UE based on the paging relay request message received from the base station. The paging record list 922 may include the full paging record list 922 in the paging message 920 on the Uu interface if the relay UE does not have the UE-identity of the target UE and does not know whether the paging message 920 is dedicated to the target UE.

The relay UE may include the additional message 924 in the paging message 920 based on the paging type indicated in the SCI-2. The additional message 924 may be optional and be omitted. Table 3 illustrates the association between the paging type in the SCI-2 and the content of the additional message 924 of the paging message 920.

TABLE 3
Paging type and additional message

| Paging type (in SCI-2) | Additional message |
|---|---|
| Triggering RRC setup | PRACH resources for |
| through Uu | random access |
| Triggering RRC setup | Sidelink resource for unicast |
| through PC5 | connection setup |
| System Information Modification | New system information |
| ETWS/CMAS notification | ETWS/CMAS message |

The additional message 924 may include the PRACH resources for random access based on the paging type of the SCI-2 being associated with triggering the RRC setup via the Uu interface. The additional message 924 may include the sidelink resources for a unicast connection setup based on the paging type of the SCI-2 being associated with triggering the RRC setup via the PC5 interface. The additional message 924 may include new SI based on the paging type of the SCI-2 being associated with the system information modification. The additional message 924 may include an emergency message such as the ETWS/CMAS message based on the paging type of the SCI-2 being associated with the ETWS/CMAS notification.

In some aspects, the paging type may be the SI modification or the ETWS/CMAS message (targeting all the UEs) contained in SCI-2, and the paging message 920 may be optional. That is, the SCI-2 may include the paging type of the paging message 920, and the SCI-2 may indicate that the paging type of the paging message 920 is associated with the SI modification or the ETWS/CMAS message. The paging message 920 may be associated with the SI modification, or the ETWS/CMAS message is targeted at all the UEs, and the UE-Identity/paging record list 922 may be omitted. Therefore, the paging message 920 transmitted in the PSSCH may be omitted when the SCI-2 includes the paging type indicating that the paging message 920 is associated with the SI modification or the ETWS/CMAS message.

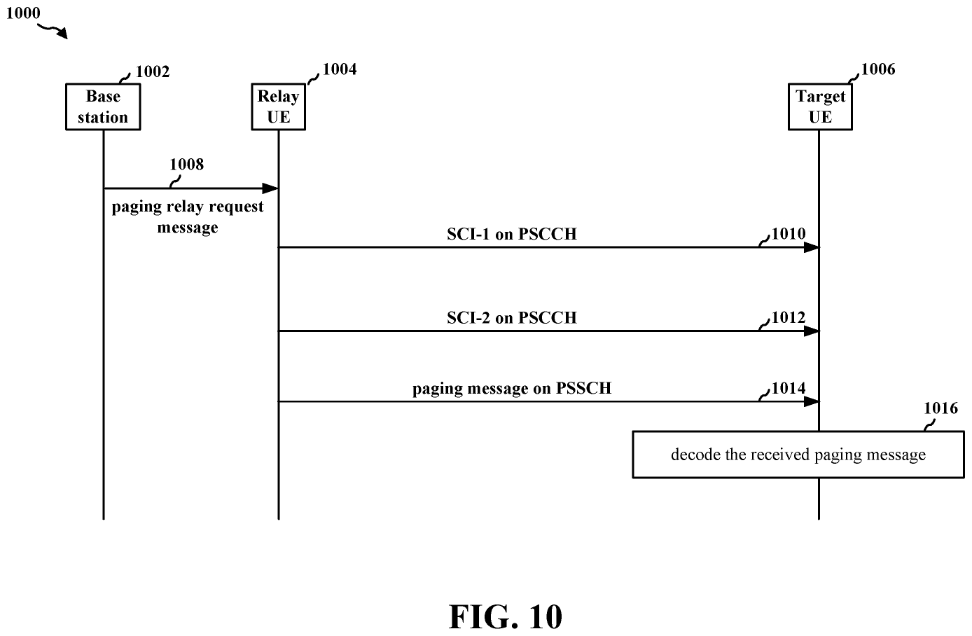

FIG. 10 is a call-flow diagram 1000 of a method of wireless communication. The wireless communication of FIG. 10 may include a base station 1002, a relay UE 1004, and a target UE 1006. The relay UE 1004 may receive, from the base station 1002, a paging relay request message including a paging message for the target UE 1006, the paging relay request message requesting the relay UE 1004 to transmit the paging message to the target UE 1006, and transmit an SCI-1 and/or an SCI-2 and the paging message to the target UE 1006 through one or more sidelink channels based on the received paging relay request message. The target UE 1006 may decode the paging message received from the relay UE 1004.

At 1008, the relay UE 1004 may receive, from a base station 1002, a paging relay request message including a paging message for a target UE 1006. The base station 1002 may transmit the paging relay request message to the relay UE 1004 to request the relay UE 1004 to transmit the paging message to the target UE 1006. The relay UE 1004 may transmit the paging message to the target UE 1006 through one or more sidelink channels based on the received paging relay request message. The one or more sidelink channels may include the PSCCH and the PSSCH, and the relay UE 1004 may transmit SCI in the PSCCH and transmit the paging message in the PSSCH to the target UE 1006.

At 1010, the relay UE 1004 may transmit the SCI in the PSCCH to the target UE 1006. The SCI may indicate the time-frequency resources allocated for the paging message within the PSSCH. The SCI transmitted in the PSCCH may be transmitted in the SCI format 1 (SCI-1) message. When the relay UE 1004 transmits two-stage SCI, the two-stage SCI may further include a second stage SCI transmitted in the SCI format 2 (SCI-2) message within the PSSCH. The SCI-1 may indicate the time-frequency resources allocated for the SCI-2 and the paging message within the PSSCH.

At 1012, the relay UE 1004 may transmit the SCI-2 in the PSSCH to the target UE 1006. The SCI-2 transmitted within the PSSCH may indicate information for decoding the paging message. The SCI-2 may further indicate the paging type of the paging message. The paging type may include triggering RRC setup through the Uu interface or the PC5 interface, modifying the SI, or notifying the emergency message such as the ETWS/CMAS notification.

At 1014, the relay UE 1004 may transmit the paging message in the PSSCH to the target UE 1006. The paging message may be transmitted in the time-frequency resources indicated through the transmitted SCI-1. The paging message may be transmitted with a header, and the header may include a source ID, a destination ID, and a frame type. The source ID may identify the relay UE 1004, the destination ID may identify the target UE 1006, and the frame type may identify that the paging message is for paging.

The paging message may include a UE-identity/paging record list and/or an additional message. The UE-identity/paging record list may indicate at least one identity associated with paged target UE 1006s. The additional message may indicate one of SI, ETWS/CMAS message, or PRACH resources. The additional message may be omitted. The paging message may also include the paging type when the SCI transmitted by the relay UE 1004 has one-stage, or the SCI-2 does not include the paging type. The paging type may include triggering an RRC setup via the Uu interface or the PC5 interface, modifying the SI, or notifying the emergency message such as the ETWS/CMAS notification.

The additional message may indicate the PRACH resources for random access associated with the paging type of triggering the RRC setup through a Uu interface. The additional message may indicate the sidelink resources for a unicast connection setup associated with the paging type of triggering the RRC setup through a PC5 interface. The additional message may indicate the new SI associated with the paging type of the SI modification. The additional message may indicate the ETWS/CMAS message associated with the paging type of the ETWS/CMAS notification.

At 1016, the target UE 1006 may decode the paging message received in the PSSCH from the relay UE 1004. The target UE 1006 may decode the paging message based on the SCI-1 received in the PSCCH and/or the SCI-2 received in the PSSCH.

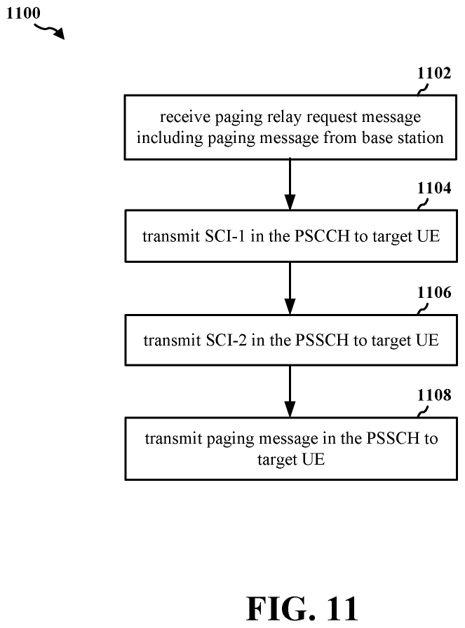

FIG. 11 is a flowchart 1100 of a method of wireless communication. The method may be performed by a second UE (e.g., the relay UE 104, 504, 1004; the apparatus 1502). The second UE may be a relay UE. The second UE may receive, from a base station, a paging relay request message including a paging message for a first UE, the paging relay request message requesting the second UE to transmit the paging message to the first UE. The second UE may transmit an SCI-1 and/or an SCI-2 and the paging message to the first UE through one or more sidelink channels based on the received paging relay request message.

At 1102, the second UE may be configured to receive, from a base station, a paging relay request message including a paging message for a target UE. The paging relay request message may be transmitted by the base station to request the second UE to transmit the paging message to the target UE. For example, at 1008, the relay UE 1002 may receive, from a base station 1002, a paging relay request message including a paging message for a target UE 1006. Furthermore, 1102 may be performed by a sidelink paging component 1540.

The second UE may be configured to transmit the paging message to the target UE through one or more sidelink channels based on the received paging relay request message. The one or more sidelink channels may include a PSCCH and a PSSCH, and the second UE may transmit an SCI and the paging message. The SCI may include a first SCI, e.g., the SCI-1, and a second SCI, e.g., the SCI-2.

At 1104, the second UE may be configured to transmit the first SCI in the PSCCH to the target UE. The first SCI may indicate time-frequency resources allocated for the paging message within the PSSCH. The first SCI may also indicate time-frequency resources allocated for the second SCI. For example, at 1010, the relay UE 1004 may transmit the SCI in the PSCCH to the target UE 1006. Furthermore, 1104 may be performed by an SCI component 1542.

At 1106, the second UE may be configured to transmit a second SCI in the PSSCH to the target UE. The second SCI may be transmitted in the time-frequency resources indicated through the transmitted first SCI, and the second SCI may indicate information for decoding the paging message. The second SCI may also include a paging type of the paging message. For example, at 1012, the relay UE 1004 may transmit the SCI-2 in the PSSCH to the target UE 1006. Furthermore, 1106 may be performed by the SCI component 1542.

At 1108, the second UE may be configured to transmit the paging message in the PSSCH to the target UE. The paging message may be transmitted in the time-frequency resources indicated through the transmitted first SCI. The paging message may be transmitted with a header, and the header may include a source ID identifying the second UE, a destination ID identifying the target UE, and a frame type identifying that the paging message is for paging. The paging message may include at least one ID associated with paged UEs, the at least one identity including an ID of the target UE. The paging message may include the paging type including at least one of triggering RRC Setup through the Uu interface or the PC5 interface, modifying the SI, or notifying the emergency message such as the ETWS/CMAS notification. The paging message may include an additional message. The additional message may indicate the PRACH resources for random access associated with the paging type of triggering the RRC setup through a Uu interface. The additional message may indicate the sidelink resources for a unicast connection setup associated with the paging type of triggering the RRC setup through a PC5 interface. The additional message may indicate the new SI associated with the paging type of the SI modification. The additional message may indicate the ETWS/CMAS message associated with the paging type of the ETWS/CMAS notification. For example, at 1014, the relay UE 1004 may transmit the paging message in the PSSCH to the target UE 1006. Furthermore, 1108 may be performed by the sidelink paging component 1540.

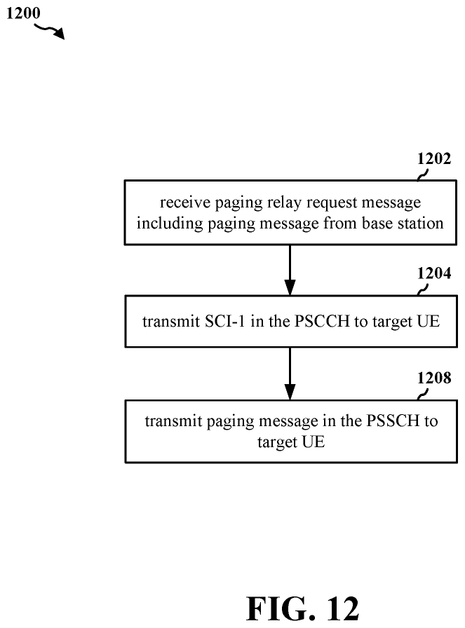

FIG. 12 is a flowchart 1200 of a method of wireless communication. The method may be performed by a second UE (e.g., the relay UE 104, 504, 1004; the apparatus 1502). The second UE may be a relay UE. The second UE may receive, from a base station, a paging relay request message including a paging message for a first UE, the paging relay request message requesting the second UE to transmit the paging message to the first UE. The second UE may transmit an SCI-1 and/or an SCI-2 and the paging message to the first UE through one or more sidelink channels based on the received paging relay request message.

At 1202, the second UE may be configured to receive, from a base station, a paging relay request message including a paging message for a target UE. The paging relay request message may be transmitted by the base station to request the second UE to transmit the paging message to the target UE. For example, at 1008, the relay UE 1002 may receive, from a base station 1002, a paging relay request message including a paging message for a target UE 1006. Furthermore, 1202 may be performed by a sidelink paging component 1540.

The second UE may be configured to transmit the paging message to the target UE through one or more sidelink channels based on the received paging relay request message. The one or more sidelink channels may include a PSCCH and a PSSCH, and the second UE may transmit an SCI and the paging message. The SCI may include a first SCI, e.g., the SCI-1, and a second SCI, e.g., the SCI-2.

At 1204, the second UE may be configured to transmit the first SCI in the PSCCH to the target UE. The first SCI may indicate time-frequency resources allocated for the paging message within the PSSCH. The first SCI may also indicate time-frequency resources allocated for the second SC. For example, at 1010, the relay UE 1004 may transmit the SCI in the PSCCH to the target UE 1006. Furthermore, 1204 may be performed by an SCI component 1542.

At 1208, the second UE may be configured to transmit the paging message in the PSSCH to the target UE. The paging message may be transmitted in the time-frequency resources indicated through the transmitted first SCI. The paging message may be transmitted with a header, and the header may include a source ID identifying the second UE, a destination ID identifying the target UE, and a frame type identifying that the paging message is for paging. The paging message may include at least one ID associated with paged UEs, the at least one identity including an ID of the target UE. The paging message may include the paging type including at least one of triggering RRC Setup through the Uu interface or the PC5 interface, modifying the SI, or notifying the emergency message such as the ETWS/CMAS notification. The paging message may include an additional message. The additional message may indicate the PRACH resources for random access associated with the paging type of triggering the RRC setup through a Uu interface. The additional message may indicate the sidelink resources for a unicast connection setup associated with the paging type of triggering the RRC setup through a PC5 interface. The additional message may indicate the new SI associated with the paging type of the SI modification. The additional message may indicate the ETWS/CMAS message associated with the paging type of the ETWS/CMAS notification. For example, at 1014, the relay UE 1004 may transmit the paging message in the PSSCH to the target UE 1006. Furthermore, 1208 may be performed by the sidelink paging component 1540.

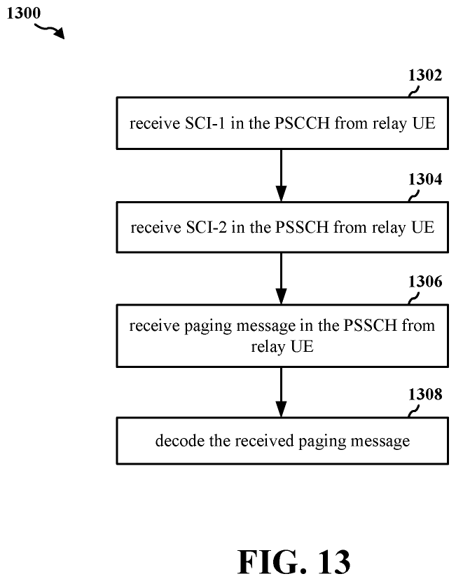

FIG. 13 is a flowchart 1300 of a method of wireless communication. The method may be performed by a first UE (e.g., the target UE 105, 506, 1006; the apparatus 1602). The first UE may be the target UE. The first UE may be configured to receive a paging message from a relay UE through one or more sidelink channels. The one or more sidelink channels may include a PSCCH and a PSSCH, and the first UE may receive an SCI and the paging message. The SCI may include a first SCI and a second SCI.

At 1302, the first UE may be configured to receive the first SCI in the PSCCH from the relay UE (i.e., at 1010). The first SCI may indicate time-frequency resources allocated for the paging message within the PSSCH. The first SCI may also indicate time-frequency resources allocated for the second SCI. For example, at 1010, the target UE 1006 may receive the first SCI (e.g., SCI type 1). Furthermore, 1302 may be performed by an SCI component 1642.

At 1304, the first UE may be configured to receive a second SCI in the PSSCH from the relay UE (i.e., at 1012). The second SCI may be received in the time-frequency resources indicated through the transmitted first SCI, and the second SCI may indicate information for decoding the paging message. The second SCI may also include a paging type of the paging message. For example, at 1012, the target UE 1006 may receive, from the relay UE 1004, the second SCI (e.g., SCI type 2) in the PSSCH. Furthermore, 1304 may be performed by the SCI component 1642.

At 1306, the first UE may be configured to receive the paging message in the PSSCH from the relay UE (i.e., at 1014). The paging message may be received in the time-frequency resources indicated through the transmitted first SCI. The paging message may be received with a header, and the header may include a source ID identifying the relay UE, a destination ID identifying the first UE, and a frame type identifying that the paging message is for paging. The paging message may include at least one ID associated with paged UEs, the at least one identity including an ID of the first UE. The paging message may include the paging type including at least one of triggering an RRC setup through the Uu interface or the PC5 interface, modifying the SI, or notifying the emergency message such as the ETWS/CMAS notification. The paging message may include an additional message. The additional message may indicate the PRACH resources for random access associated with the paging type of triggering the RRC setup through a Uu interface. The additional message may indicate the sidelink resources for a unicast connection setup associated with the paging type of triggering the RRC setup through a PC5 interface. The additional message may indicate the new SI associated with the paging type of the SI modification. The additional message may indicate the ETWS/CMAS message associated with the paging type of the ETWS/CMAS notification. For example, at 1014, the target UE 1006 may receive, from the relaying UE 1004, the paging message in the PSSCH. Furthermore, 1306 may be performed by a sidelink paging component 1640.

At 1308, the first UE may be configured to decode the received paging message (i.e., at 1016). The first UE may decode the paging message based on the first SCI received in the PSCCH and/or the second SCI received in the PSSCH. For example, at 1016, the target UE 1006 may decode the paging message received in the PSSCH from the relay UE 1004. Furthermore, 1306 may be performed by the sidelink paging component 1640.

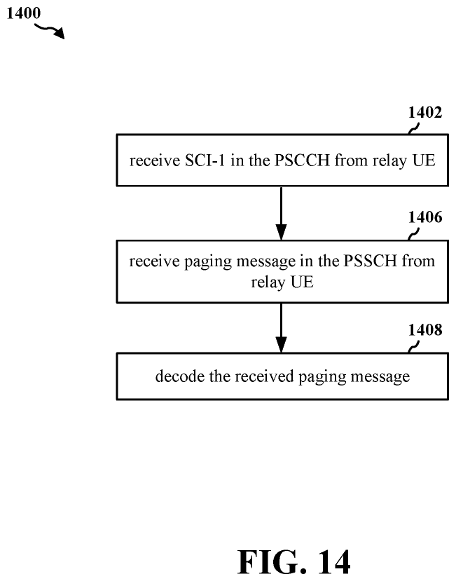

FIG. 14, is a flowchart 1400 of a method of wireless communication. The method may be performed by a first UE (e.g., the target UE 105, 506, 1006; the apparatus 1602). The first UE may be the target UE. The first UE may be configured to receive a paging message from a relay UE through one or more sidelink channels. The one or more sidelink channels may include a PSCCH and a PSSCH, and the first UE may receive an SCI and the paging message. The SCI may include a first SCI and a second SCI.

At 1402, the first UE may be configured to receive the first SCI in the PSCCH from the relay UE (i.e., at 1010). The first SCI may indicate time-frequency resources allocated for the paging message within the PSSCH. The first SCI may also indicate time-frequency resources allocated for the second SCI. For example, at 1010, the target UE 1006 may receive the first SCI (e.g., SCI type 1). Furthermore, 1402 may be performed by an SCI component 1642.

At 1406, the first UE may be configured to receive the paging message in the PSSCH from the relay UE (i.e., at 1014). The paging message may be received in the time-frequency resources indicated through the transmitted first SCI. The paging message may be received with a header, and the header may include a source ID identifying the relay UE, a destination ID identifying the first UE, and a frame type identifying that the paging message is for paging. The paging message may include at least one ID associated with paged UEs, the at least one identity including an ID of the first UE. The paging message may include the paging type including at least one of triggering an RRC setup through the Uu interface or the PC5 interface, modifying the SI, or notifying the emergency message such as the ETWS/CMAS notification. The paging message may include an additional message. The additional message may indicate the PRACH resources for random access associated with the paging type of triggering the RRC setup through a Uu interface. The additional message may indicate the sidelink resources for a unicast connection setup associated with the paging type of triggering the RRC setup through a PC5 interface. The additional message may indicate the new SI associated with the paging type of the SI modification. The additional message may indicate the ETWS/CMAS message associated with the paging type of the ETWS/CMAS notification. For example, at 1014, the target UE 1006 may receive, from the relaying UE 1004, the paging message in the PSSCH. Furthermore, 1406 may be performed by a sidelink paging component 1640.

At 1408, the first UE may be configured to decode the received paging message (i.e., at 1016). The first UE may decode the paging message based on the first SCI received in the PSCCH and/or the second SCI received in the PSSCH. For example, at 1016, the target UE 1006 may decode the paging message received in the PSSCH from the relay UE 1004. Furthermore, 1406 may be performed by the sidelink paging component 1640.

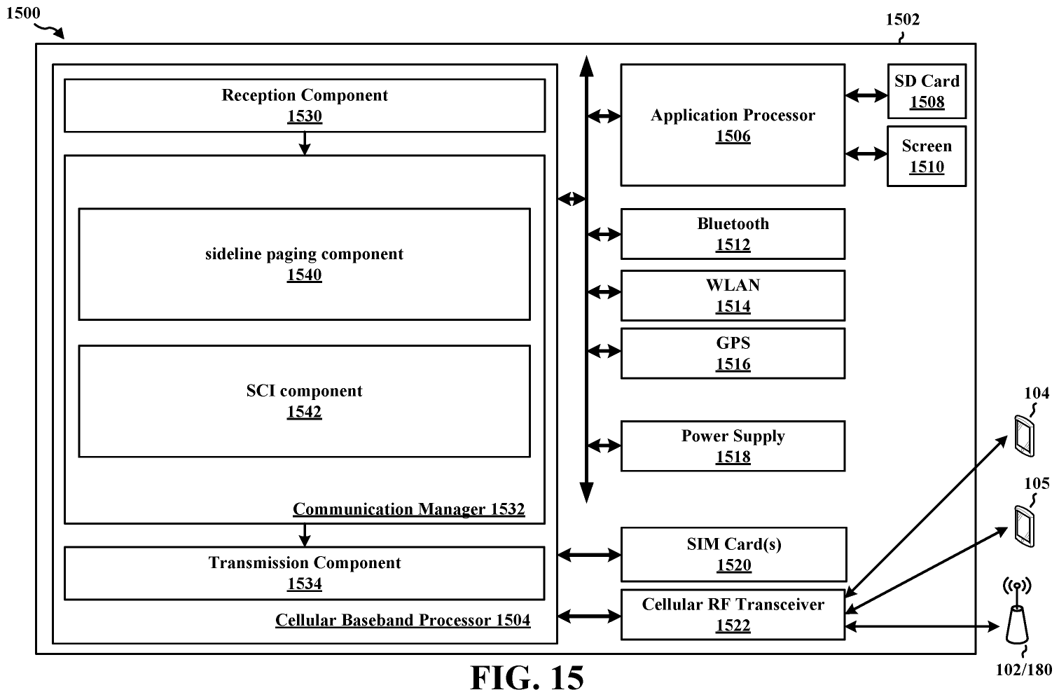

FIG. 15 is a diagram 1500 illustrating an example of a hardware implementation for an apparatus 1502. The apparatus 1502 is a relay UE and includes a cellular baseband processor 1504 (also referred to as a modem) coupled to a cellular RF transceiver 1522 and one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, and a power supply 1518. The cellular baseband processor 1504 communicates through the cellular RF transceiver 1522 with another relay UE 104, a target UE 105, and/or BS 102/180. The cellular baseband processor 1504 may include a computer-readable medium/memory. The computer-readable medium/memory may be non-transitory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the UE 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see 350 of FIG. 3) and include the aforediscussed additional modules of the apparatus 1502.

The communication manager 1532 includes a sidelink paging component 1540 that is configured to transmit the first SCI in the PSCCH to the target UE and transmit the paging message in the PSSCH to the target UE, e.g., as described in connection with 1102, 1108, 1202, and 1208. The communication manager 1532 further includes an SCI component 1542 that is configured to transmit the first SCI in the PSCCH to the target UE and transmit a second SCI in the PSSCH to the target UE, e.g., as described in connection with 1104, 1106, and 1204.

The apparatus may include additional components that perform each of the blocks of the algorithm in the aforementioned flowcharts of FIGS. 10 and 11. As such, each block in the aforementioned flowcharts of FIGS. 10 and 11 may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1502, and in particular the cellular baseband processor 1504, includes means for receiving, from a base station, a paging relay request message including a paging message for a second UE, the paging relay request message requesting the first UE to transmit the paging message to the second UE, and means for transmitting the paging message to the second UE through one or more sidelink channels based on the received paging relay request message. The apparatus 1502 includes means for transmitting SCI in the PSCCH to the second UE, the SCI indicating time-frequency resources allocated for the paging message within the PSSCH, and means for transmitting the paging message in the PSSCH to the second UE, the paging message being transmitted in the time-frequency resources indicated through the transmitted SC. The apparatus 1502 includes means for transmitting first SCI in the PSCCH, the first SCI indicating time-frequency resources allocated for second SCI and the paging message within the PSSCH, means for transmitting the second SCI in the PSSCH to the second UE, the second SCI indicating information for decoding the paging message, the second SCI being transmitted in the time-frequency resources indicated through the transmitted first SCI, and means for transmitting the paging message in the PSSCH to the second UE, the paging message being transmitted in the time-frequency resources indicated through the transmitted first SCI. The apparatus 1502 includes means for transmitting first SCI in the PSCCH, the first SCI indicating time-frequency resources allocated for second SCI within the PSSCH, and means for transmitting the second SCI in the PSSCH, the second SCI being transmitted in the time-frequency resources indicated through the transmitted first SCI, the second SCI indicating a paging type including at least one of a SI modification or an ETWS/CMAS notification. The aforementioned means may be one or more of the aforementioned components of the apparatus 1502 configured to perform the functions recited by the aforementioned means. As described supra, the apparatus 1502 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

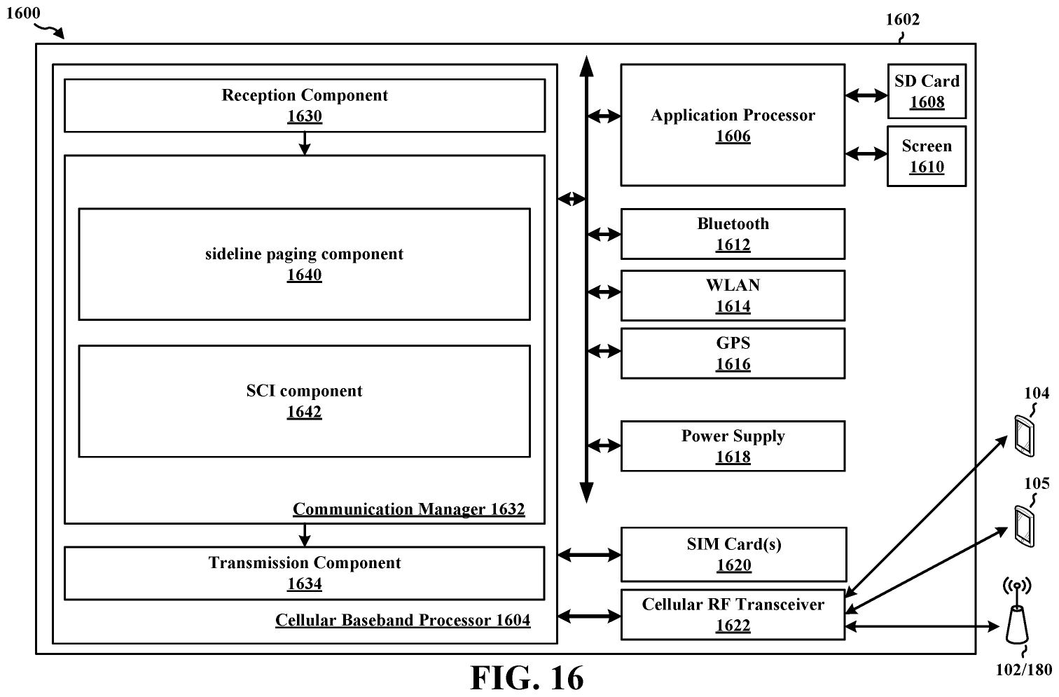

FIG. 16 is a diagram 1600 illustrating an example of a hardware implementation for an apparatus 1602. The apparatus 1602 is a UE and includes a cellular baseband processor 1604 (also referred to as a modem) coupled to a cellular RF transceiver 1622 and one or more subscriber identity modules (SIM) cards 1620, an application processor 1606 coupled to a secure digital (SD) card 1608 and a screen 1610, a Bluetooth module 1612, a wireless local area network (WLAN) module 1614, a Global Positioning System (GPS) module 1616, and a power supply 1618. The cellular baseband processor 1604 communicates through the cellular RF transceiver 1622 with the relay UE 104, another target UE 105, and/or BS 102/180. The cellular baseband processor 1604 may include a computer-readable medium/memory. The computer-readable medium/memory may be non-transitory. The cellular baseband processor 1604 is responsible for general processing, including the execution of software stored on the computer-readable medium/memory. The software, when executed by the cellular baseband processor 1604, causes the cellular baseband processor 1604 to perform the various functions described supra. The computer-readable medium/memory may also be used for storing data that is manipulated by the cellular baseband processor 1604 when executing software. The cellular baseband processor 1604 further includes a reception component 1630, a communication manager 1632, and a transmission component 1634. The communication manager 1632 includes the one or more illustrated components. The components within the communication manager 1632 may be stored in the computer-readable medium/memory and/or configured as hardware within the cellular baseband processor 1604. The cellular baseband processor 1604 may be a component of the UE 350 and may include the memory 360 and/or at least one of the TX processor 368, the RX processor 356, and the controller/processor 359. In one configuration, the apparatus 1602 may be a modem chip and include just the baseband processor 1604, and in another configuration, the apparatus 1602 may be the entire UE (e.g., see 350 of FIG. 3) and include the aforediscussed additional modules of the apparatus 1602.

The communication manager 1632 includes a sidelink paging component 1640 that is configured to receive a paging message in a PSSCH from the relay UE and decode the received paging message, e.g., as described in connection with 1306, 1308, 1406, and 1408. The communication manager 1632 further includes an SCI component 1642 that is configured to receive a first SCI in the PSCCH and a second SCI in the PSSCH from the relay UE, e.g., as described in connection with 1302, 1304, and 1402.

The apparatus may include additional components that perform each of the blocks of the algorithm in the aforementioned flowcharts of FIGS. 10 and 12. As such, each block in the aforementioned flowcharts of FIGS. 10 and 12 may be performed by a component, and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1602, and in particular the cellular baseband processor 1604, includes means for receiving, from a first UE, a paging message through one or more sidelink channels, and means for decoding the received paging message. The apparatus 1602 includes means for receiving SCI in the PSCCH from the first UE, the SCI indicating time-frequency resources allocated for the paging message within the PSSCH, and means for receiving the paging message in the PSSCH from the first UE, the paging message being received in the time-frequency resources indicated through the received SC. The apparatus 1602 includes means for receiving the second SCI in the PSSCH from the first UE, the second SCI indicating information for decoding the paging message, the second SCI being received in the time-frequency resources indicated through the received first SCI, the paging message being decoded based on the information received in the second SCI, and means for receiving the paging message in the PSSCH from the first UE, the paging message being received in the time-frequency resources indicated through the received first SCI. The apparatus 1602 includes means for receiving first SCI in the PSCCH from the first UE, the first SCI indicating time-frequency resources allocated for second SCI within the PSSCH, and means for receiving the second SCI in the PSSCH from the first UE, the second SCI being received in the time-frequency resources indicated through the received first SCI, the second SCI indicating a paging type including at least one of a SI modification or an ETWS/CMAS notification. The aforementioned means may be one or more of the aforementioned components of the apparatus 1602 configured to perform the functions recited by the aforementioned means. As described supra, the apparatus 1602 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Referring again to FIGS. 5, 6, 7, 8, 9, 10, 11, 12, 15, and 16, a method of wireless communication of a relay UE may include receiving, from a base station, a paging relay request message including a paging message for a target UE, the paging relay request message requesting the relay UE to transmit the paging message to the target UE, and transmitting the paging message to the target UE through one or more sidelink channels based on the received paging relay request message. The target UE may receive, from the relay UE, a paging message through one or more sidelink channels and decode the received paging message.

The one or more sidelink channels may include a PSCCH and a PSSCH. The paging message to the target UE may include SCI transmitted in the PSCCH to the target UE, the SCI indicating time-frequency resources allocated for the paging message within the PSSCH, and the paging message transmitted in the PSSCH to the target UE, the paging message being transmitted in the time-frequency resources indicated through the transmitted SCI. The SCI may be transmitted in an SCI-1 message.

The paging message may be transmitted with a header, where the header may include a source ID identifying the relay UE, a destination ID identifying the target UE, and a frame type identifying that paging message may be for paging, and the paging message may include a paging type, and at least one identity associated with paged UEs, the at least one identity including an identity of the target UE.

The paging message may include an additional message indicating PRACH resources for random access, the paging type being associated with triggering the RRC setup through a Uu interface. The paging message may include an additional message indicating sidelink resources for a unicast connection setup, the paging type being associated with triggering the RRC setup through a PC5 interface. The paging message may include an additional message indicating new SI, the paging type being associated with a system information modification. Furthermore, the paging message may include an additional message indicating an ETWS/CMAS message, the paging type being associated with an ETWS/CMAS notification.

The paging message transmitted by the UE to the target UE may include the first SCI in the PSCCH, and the second SCI in the PSSCH to the target UE the first SCI indicating time-frequency resources allocated for the second SCI and the paging message within the PSSCH. The second SCI may indicate information for decoding the paging message, the second SCI being transmitted in the time-frequency resources indicated through the transmitted first SCI, and transmitting the paging message in the PSSCH to the target UE, the paging message being transmitted in the time-frequency resources indicated through the transmitted first SCI. The first SCI may be transmitted in the SCI-1 message, and the second SCI may be transmitted in the SCI-2 message. The paging type may be transmitted in the SCI-2 in the PSSCH.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication of a second UE, the method including receiving, from a base station, a paging relay request message including a paging message for a first UE, the paging relay request message requesting the second UE to transmit the paging message to the first UE and transmitting the paging message to the first UE through one or more sidelink channels based on the received paging relay request message.

Aspect 2 is the method of aspect 1, where the one or more sidelink channels includes a PSCCH and a PSSCH. Transmitting the paging message to the first UE includes transmitting SCI in the PSCCH to the first UE, the SCI indicating time-frequency resources allocated for the paging message within the PSSCH, and transmitting the paging message in the PSSCH to the first UE. The paging message is transmitted in the time-frequency resources indicated through the transmitted SCI.

Aspect 3 is the method of aspect 2, where the SCI is transmitted in an SCI-1 message.

Aspect 4 is the method of any of aspects 2 and 3, where the paging message is transmitted with a header. The header includes a source ID identifying the second UE, a destination ID identifying the first UE, and a frame type identifying that paging message is for paging; and the paging message includes a paging type, and at least one identity associated with paged UEs, the at least one identity including an identity of the first UE.

Aspect 5 is the method of aspect 4, where the paging message further includes an additional message indicating PRACH resources for random access, the paging type being associated with triggering an RRC setup through a Uu interface.

Aspect 6 is the method of aspect 4, where the paging message further includes an additional message indicating sidelink resources for a unicast connection setup, the paging type being associated with triggering the RRC setup through a PC5 interface.

Aspect 7 is the method of aspect 4, where the paging message further includes an additional message indicating new SI, the paging type being associated with a system information modification.

Aspect 8 is the method of aspect 4, where the paging message further includes an additional message indicating an ETWS/CMAS message, the paging type being associated with an ETWS/CMAS notification.

Aspect 9 is the method of aspect 1, where the one or more sidelink channels includes the PSCCH and the PSSCH. The transmitting the paging message to the first UE include transmitting the first SCI in the PSCCH, the first SCI indicating time-frequency resources allocated for the second SCI and the paging message within the PSSCH, transmitting the second SCI in the PSSCH to the first UE, the second SCI indicating information for decoding the paging message, the second SCI being transmitted in the time-frequency resources indicated through the transmitted first SCI, and transmitting the paging message in the PSSCH to the first UE. The paging message is transmitted in the time-frequency resources indicated through the transmitted first SCI.

Aspect 10 is the method of aspect 9, where the first SCI is transmitted in an SCI-1 message, and the second SCI is transmitted in an SCI-2 message.

Aspect 11 is the method of any of aspects 9 and 10, where the paging message is transmitted with a header. The header includes a source ID identifying the second UE, a destination ID identifying the first UE, and a frame type identifying that paging message is for paging, and the paging message includes at least one identity associated with paged UEs, the at least one identity including an identity of the first UE.

Aspect 12 is the method of aspect 11, where the paging message further includes a paging type.

Aspect 13 is the method of aspect 11, where the second SCI further indicates a paging type.

Aspect 14 is the method of any of aspects 11 to 13, where the paging message further includes an additional message indicating PRACH resources for random access, the PRACH resources for random access being associated with a paging type of triggering the RRC setup through a Uu interface.

Aspect 15 is the method of any of aspects 11 to 13, where the paging message further includes an additional message indicating sidelink resources for a unicast connection setup, the sidelink resources for a unicast connection setup being associated with a paging type of triggering the RRC setup through a PC5 interface.

Aspect 16 is the method of any of aspects 11 to 13, where the paging message further includes an additional message indicating new SI, the new SI being associated with a paging type of a system information modification.

Aspect 17 is the method of any of aspects 11 to 13, where the paging message further includes an additional message indicating the ETWS/CMAS message, the ETWS/CMAS message being associated with a paging type of an ETWS/CMAS notification.

Aspect 18 is the method of aspect 1, where the one or more sidelink channels includes a PSCCH and a PSSCH. The transmitting the paging message to the first UE includes transmitting the first SCI in the PSCCH, the first SCI indicating time-frequency resources allocated for the second SCI within the PSSCH, and transmitting the second SCI in the PSSCH, the second SCI being transmitted in the time-frequency resources indicated through the transmitted first SCI, the second SCI indicating a paging type including at least one of an SI modification or an ETWS/CMAS notification.

Aspect 19 is an apparatus for wireless communication including at least one processor coupled to a memory and configured to implement a method as in any of aspects 1 to 18, further including at least one of an antenna or a transceiver coupled to the at least one processor.

Aspect 20 is an apparatus for wireless communication including means for implementing a method as in any of aspects 1 to 18.

Aspect 21 is a computer-readable medium storing computer-executable code, where the code when executed by a processor causes the processor to implement a method as in any of aspects 1 to 18.

Aspect 22 is a method of wireless communication of a first UE, the method including receiving, from a second UE, a paging message through one or more sidelink channels, and decoding the received paging message.

Aspect 23 is the method of aspect 22, where the one or more sidelink channels includes a PSCCH and a PSSCH. The receiving the paging message from the second UE includes receiving SCI in the PSCCH from the second UE, the SCI indicating time-frequency resources allocated for the paging message within the PSSCH, and receiving the paging message in the PSSCH from the second UE, the paging message being received in the time-frequency resources indicated through the received SCI.

Aspect 24 is the method of aspect 23, where the SCI is received in the SCI-1 message.

Aspect 25 is the method of any of aspects 23 and 24, where the paging message is received with a header, where the header includes an ID identifying the second UE, a destination ID identifying the first UE, and a frame type identifying that paging message is for paging, and the paging message includes a paging type, and at least one identity associated with paged UEs, the at least one identity including an identity of the first UE.

Aspect 26 is the method of aspect 25, where the paging message further includes an additional message indicating PRACH resources for random access, the paging type being associated with triggering the RRC setup through a Uu interface.

Aspect 27 is the method of aspect 25, where the paging message further includes an additional message indicating sidelink resources for a unicast connection setup, the paging type being associated with triggering the RRC setup through a PC5 interface.

Aspect 28 is the method of aspect 25, where the paging message further includes an additional message indicating new SI, the paging type being associated with a system information modification.

Aspect 29 is the method of aspect 25, where the paging message further includes an additional message indicating ETWS/CMAS message, the paging type being associated with an ETWS/CMAS notification.

Aspect 30 is the method of aspect 22, where the one or more sidelink channels includes a PSCCH and a PSSCH. The receiving the paging message from the second UE includes receiving the first SCI in the PSCCH from the second UE, the first SCI indicating time-frequency resources allocated for the second SCI and the paging message within the PSSCH, receiving the second SCI in the PSSCH from the second UE, the second SCI indicating information for decoding the paging message, the second SCI being received in the time-frequency resources indicated through the received first SCI, the paging message being decoded based on the information received in the second SCI, and receiving the paging message in the PSSCH from the second UE, the paging message being received in the time-frequency resources indicated through the received first SCI.

Aspect 31 is the method of aspect 30, where the first SCI is received in the SCI-1 message and the second SCI is received in the SCI-2 message.

Aspect 32 is the method of any of aspects 30 and 31, where the paging message is received with a header. The header includes the ID identifying the second UE, a destination ID identifying the first UE, and a frame type identifying that paging message is for paging, and the paging message includes at least one identity associated with paged UEs, the at least one identity including an identity of the first UE.

Aspect 33 is the method of aspect 32, where the paging message further includes a paging type.

Aspect 34 is the method of aspect 32, where the second SCI further indicates a paging type.

Aspect 35 is the method of any of aspects 32 to 34, where the paging message further includes an additional message indicating PRACH resources for random access, the PRACH resources for random access being associated with a paging type of triggering the RRC setup through a Uu interface.

Aspect 36 is the method of any of aspects 32 to 34, where the paging message further includes an additional message indicating sidelink resources for a unicast connection setup, the sidelink resources for a unicast connection setup being associated with a paging type of triggering the RRC setup through a PC5 interface.

Aspect 37 is the method of any of aspects 32 to 34, where the paging message further includes an additional message indicating new SI, the new SI being associated with a paging type of a system information modification.

Aspect 38 is the method of any of aspects 32 to 34, where the paging message further includes an additional message indicating ETWS/CMAS message, the ETWS/CMAS message being associated with a paging type of an ETWS/CMAS notification.

Aspect 39 is the method of aspect 22, where the one or more sidelink channels includes a PSCCH and a PSSCH. The receiving the paging message from the second UE includes receiving the first SCI in the PSCCH from the second UE, the first SCI indicating time-frequency resources allocated for second SCI within the PSSCH, and receiving the second SCI in the PSSCH from the second UE, the second SCI being received in the time-frequency resources indicated through the received first SCI, the second SCI indicating a paging type including at least one of a SI modification or ETWS/CMAS notification.

Aspect 40 is an apparatus for wireless communication including at least one processor coupled to a memory and configured to implement a method as in any of aspects 22 to 39, further including at least one of an antenna or a transceiver coupled to the at least one processor.

Aspect 41 is an apparatus for wireless communication including means for implementing a method as in any of aspects 22 to 39.

Aspect 42 is a computer-readable medium storing computer-executable code, where the code when executed by a processor causes the processor to implement a method as in any of aspects 22 to 39.

What is claimed is:

1. An apparatus for wireless communication at a second user equipment (UE), comprising:
a memory; and
at least one processor coupled to the memory and configured to, at least in part with the memory;
receive, from a base station, a paging relay request message including a paging message for a first UE, the paging relay request message requesting the second UE to transmit the paging message to the first UE; and
transmit the paging message to the first UE through one or more sidelink channels based on the received paging relay request message.

2. The apparatus of claim 1, wherein the one or more sidelink channels comprises a physical sidelink control channel (PSCCH) and a physical sidelink shared channel (PSSCH), and wherein to transmit the paging message to the first UE, the at least one processor is configured to:
transmit sidelink control information (SCI) in the PSCCH to the first UE, the SCI indicating time-frequency resources allocated for the paging message within the PSSCH; and
transmit the paging message in the PSSCH to the first UE, the paging message being transmitted in the time-frequency resources indicated through the transmitted SCI.

3. The apparatus of claim 2, wherein:
the paging message is transmitted with a header;
the header includes a source identifier (ID) identifying the second UE, a destination ID identifying the first UE, and a frame type identifying that the paging message is for paging; and
the paging message includes a paging type, and at least one identity associated with paged UEs, the at least one identity including an identity of the first UE.

4. The apparatus of claim 3, wherein the paging message further includes an additional message indicating physical random access channel (PRACH) resources for random access, the paging type being associated with triggering a radio resource control (RRC) setup through a Uu interface.

5. The apparatus of claim 3, wherein the paging message further includes an additional message indicating sidelink resources for a unicast connection setup, the paging type being associated with triggering a radio resource control (RRC) setup through a PC5 interface.

6. The apparatus of claim 3, wherein the paging message further includes an additional message indicating new system information (SI), the paging type being associated with a system information modification.

7. The apparatus of claim 3, wherein the paging message further includes an additional message indicating an earthquake and tsunami warning system (ETWS)/commercial mobile alert system (CMAS) message, the paging type being associated with an ETWS/CMAS notification.

8. The apparatus of claim 1, wherein the one or more sidelink channels comprises a physical sidelink control channel (PSCCH) and a physical sidelink shared channel (PSSCH), and wherein to transmit the paging message to the first UE, the at least one processor is configured to:
transmit first sidelink control information (SCI) in the PSCCH, the first SCI indicating time-frequency resources allocated for second SCI and the paging message within the PSSCH; and
transmit the paging message in the PSSCH to the first UE, the paging message being transmitted in the time-frequency resources indicated through the transmitted first SCI.

9. The apparatus of claim 8, wherein:
the paging message is transmitted with a header;
the header includes a source identifier (ID) identifying the second UE, a destination ID identifying the first UE, and a frame type identifying that the paging message is for paging; and
the paging message includes at least one identity associated with paged UEs, the at least one identity including an identity of the first UE.

10. The apparatus of claim 9, wherein the paging message further includes an additional message indicating physical random access channel (PRACH) resources for random access, the PRACH resources for the random access being associated with a paging type of triggering a radio resource control (RRC) setup through a Uu interface.

11. The apparatus of claim 9, wherein the paging message further includes an additional message indicating sidelink resources for a unicast connection setup, the sidelink resources for the unicast connection setup being associated with a paging type of triggering a radio resource control (RRC) setup through a PC5 interface.

12. The apparatus of claim 9, wherein the paging message further includes an additional message indicating new system information (SI), the new SI being associated with a paging type of a system information modification.

13. The apparatus of claim 9, wherein the paging message further includes an additional message indicating an earthquake and tsunami warning system (ETWS)/commercial mobile alert system (CMAS) message, the ETWS/CMAS message being associated with a paging type of an ETWS/CMAS notification.

14. The apparatus of claim 1, further comprising at least one of an antenna or a transceiver coupled to the at least one processor, wherein the one or more sidelink channels comprises a physical sidelink control channel (PSCCH) and a physical sidelink shared channel (PSSCH), and wherein to transmit the paging message to the first UE, the at least one processor is configured to:
transmit first sidelink control information (SCI) in the PSCCH, the first SCI indicating time-frequency resources allocated for second SCI within the PSSCH; and
transmit the second SCI in the PSSCH, the second SCI being transmitted in the time-frequency resources indicated through the transmitted first SCI, the second SCI indicating a paging type including at least one of a system information (SI) modification or an earthquake and tsunami warning system (ETWS)/commercial mobile alert system (CMAS) notification.

15. A method of wireless communication at a second user equipment (UE), comprising:
receiving, from a base station, a paging relay request message including a paging message for a first UE, the paging relay request message requesting the second UE to transmit the paging message to the first UE; and
transmitting the paging message to the first UE through one or more sidelink channels based on the received paging relay request message.

16. An apparatus for wireless communication at a first user equipment (UE), comprising:
a memory; and
at least one processor coupled to the memory and configured to, at least in part with the memory;
receive, from a second UE, a paging message through one or more sidelink channels; and
decode the received paging message.

17. The apparatus of claim 16, wherein the one or more sidelink channels comprises a physical sidelink control channel (PSCCH) and a physical sidelink shared channel (PSSCH), and wherein to receive the paging message from the second UE, the at least one processor is configured to:
receive sidelink control information (SCI) in the PSCCH from the second UE, the SCI indicating time-frequency resources allocated for the paging message within the PSSCH; and
receive the paging message in the PSSCH from the second UE, the paging message being received in the time-frequency resources indicated through the received SCI.

18. The apparatus of claim 17, wherein:
the paging message is received with a header;
the header includes a source identifier (ID) identifying the second UE, a destination ID identifying the first UE, and a frame type identifying that the paging message is for paging; and
the paging message includes a paging type, and at least one identity associated with paged UEs, the at least one identity including an identity of the first UE.

19. The apparatus of claim 18, wherein the paging message further includes an additional message indicating physical random access channel (PRACH) resources for random access, the paging type being associated with triggering a radio resource control (RRC) setup through a Uu interface.

20. The apparatus of claim 18, wherein the paging message further includes an additional message indicating sidelink resources for a unicast connection setup, the paging type being associated with triggering a radio resource control (RRC) setup through a PC5 interface.

21. The apparatus of claim 18, wherein the paging message further includes an additional message indicating new system information (SI), the paging type being associated with a system information modification.

22. The apparatus of claim 18, wherein the paging message further includes an additional message indicating an earthquake and tsunami warning system (ETWS)/commercial mobile alert system (CMAS) message, the paging type being associated with an ETWS/CMAS notification.

23. The apparatus of claim 16, wherein the one or more sidelink channels comprises a physical sidelink control channel (PSCCH) and a physical sidelink shared channel (PSSCH), and wherein to receive the paging message from the second UE, the at least one processor is configured to:
receive first sidelink control information (SCI) in the PSCCH from the second UE, the first SCI indicating time-frequency resources allocated for second SCI and the paging message within the PSSCH; and
receive the paging message in the PSSCH from the second UE, the paging message being received in the time-frequency resources indicated through the received first SCI.

24. The apparatus of claim 23, wherein the paging message is received with a header, and a format of the header and the paging message comprises:
the header including a source identifier (ID) identifying the second UE, a destination ID identifying the first UE, and a frame type identifying that the paging message is for paging; and
the paging message including at least one identity associated with paged UEs, the at least one identity including an identity of the first UE.

25. The apparatus of claim 24, wherein the paging message further includes an additional message indicating physical random access channel (PRACH) resources for random access, the PRACH resources for the random access being associated with a paging type of triggering a radio resource control (RRC) setup through a Uu interface.

26. The apparatus of claim 24, wherein the paging message further includes an additional message indicating sidelink resources for a unicast connection setup, the sidelink resources for the unicast connection setup being associated with a paging type of triggering a radio resource control (RRC) setup through a PC5 interface.

27. The apparatus of claim 24, wherein the paging message further includes an additional message indicating new system information (SI), the new SI being associated with a paging type of a system information modification.

28. The apparatus of claim 24, wherein the paging message further includes an additional message indicating an earthquake and tsunami warning system (ETWS)/commercial mobile alert system (CMAS) message, the ETWS/CMAS message being associated with a paging type of an ETWS/CMAS notification.

29. The apparatus of claim 16, further comprising at least one of an antenna or a transceiver coupled to the at least one processor, wherein the one or more sidelink channels comprises a physical sidelink control channel (PSCCH) and a physical sidelink shared channel (PSSCH), and wherein to receive the paging message from the second UE, the at least one processor is configured to:
receive first sidelink control information (SCI) in the PSCCH from the second UE, the first SCI indicating time-frequency resources allocated for second SCI within the PSSCH; and
receive the second SCI in the PSSCH from the second UE, the second SCI being received in the time-frequency resources indicated through the received first SCI, the second SCI indicating a paging type including at least one of a system information (SI) modification or an earthquake and tsunami warning system (ETWS)/commercial mobile alert system (CMAS) notification.

30. A method of wireless communication at a first user equipment (UE), comprising:
receiving, from a second UE, a paging message through one or more sidelink channels; and
decoding the received paging message.
